(19) United States
(12) Patent Application Publication
(10) Pub. No.: US 2021/0367497 A1
(43) Pub. Date: Nov. 25, 2021

(54) POWER GENERATION USING MOTION TRANSFORMATION

(71) Applicant: FEDERICO MARQUEZ LOPEZ, CHIHUAHUA (MX)

(72) Inventor: FEDERICO MARQUEZ LOPEZ, CHIHUAHUA (MX)

(21) Appl. No.: 16/910,557

(22) PCT Filed: Dec. 17, 2018
(86) PCT No.: PCT/IB2018/060628

§ 371 Date: Jun. 24, 2020

Related U.S. Application Data
(60) Provisional application No. 62/612,323, filed on Dec. 30, 2017.
(60) Provisional application No. 62/745,325, filed on Oct. 13, 2018.

(51) Int. Cl. H02K 33/00

(52) U.S. Cl. CPC H02K 33/00

(57) ABSTRACT

The present invention is related to power generation and motion transformation. The invention allows to convert a movement into a different movement and changing the vector of the movement, speed and force, with management of the magnetic flux of permanent magnets. Mechanical mechanisms are common as transmissions, torque converters, and crankshafts, along with electric or electromagnetic conversions such as transformers or inverters. This is related to one that uses permanent magnets magnetic radiation intensity and polarity to transfer force and create a movement useful to generate power. The invention can work to convert DC to AC, AC to AC, change the frequency, or generate power.

### CROSS-REFERENCE TO RELATED PATENT DOCUMENTS

This patent application claims the benefit of priority of U.S. Provisional Application No. 62/612,323, entitled “Efficient Power Generator,” filed Dec. 30, 2017, and U.S. Provisional Application No. 62/745,325, entitled “High Density Linear Induction,” filed Oct. 13, 2018, which are hereby incorporated herein by reference in its entirety.

### FIELD OF THE INVENTION

The present invention relates generally to electric power generation, and, more particularly, to electric power generation by converting linear or rotational movement into a reciprocating motion.

### BACKGROUND

Power generator during power generation is accomplished by cutting the coil magnetic field lines. Most of the power is wasted to overcome the resistance to this reverse magnetic field generation mode, lowering the efficiency of power generation, and thus the generation of energy does not match the target. The first known electric power generation was Faraday's copper loop induced by a magnet moving through it. In the traditional mechanism, once the movement is done approximating the magnet into the iron core of the coil, there will be resistance to separate them due the attraction of the magnet to the iron. The needed force is not really wasted as the attracting force will help in the way back, but increases the top force needed. In rotary generators, this is perceived as cogging. To overcome the disadvantages of the conventional power generators, the current disclosure proposes power generation and motion transformation that should allow to convert a movement into a different movement changing the vector of the movement, speed and force, with management of the magnetic flux of permanent magnets.

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to allow to convert linear or rotational movement into a reciprocating motion to generate or convert power, the rotary or linear movement can come from different sources like electric AC or DC motor, internal combustion engine or many others and the resulting power can be reciprocating mechanical movement or electric power in different forms like AC or DC in same or different voltage, the mechanism allows to make it in a very efficient way.

It is another objective of the present invention to allow to generate electric power in a high density by using iron core coil or any other suitable high permeability core to increase magnetic flux induced into the coil and using it to increase the current and a balancing method to avoid the linear cogging due to magnetic attraction force. By this method, the needed maximum force is less even though the energy used is the same. The balance allows to have a source of power much higher at less peak force.

It is another objective of the present invention to provide a power generator by making a linear motion or oscillating movement for power generation based on changing the electromagnetic force that is shown to the permanent magnet in the stroking movement. This is useful in linear and rotational movements into axial movements for the power generation in different mechanisms. The advantage of the present invention made here is balancing of the forces of the magnets that resist the circular or linear motion translated to the oscillating movement and reducing the need power to operate the mechanism reducing cogging and power needed.

It is another objective of the present invention to facilitate use of an iron core coil or a magnetic material core coil to increase the induced current in a linear alternator or generator without having all the resistance of cogging produced by the attraction of the core to the magnet. In an embodiment, the force needed to overcome the attraction of the permanent magnet to the iron core to allow the movement can be reduced. This is obtained by contrasting the attracting force of the permanent magnet that induces the iron core with the force of two permanent magnets opposing each other by being fronted by the same polarity. Magnetic forces are exponential and increase in a very small distance which is hard to counter part by a spring or mechanical force. Making the same induction in the opposite direction can balance a little the needed force by counterpart the same movement, but is not very effective as the force of attraction of the magnet to its iron core coil is greater when they are closer, and the force of the opposed force is the moment when it is weaker so they don't balance that well. The repel between two magnets is ideal counter force. The forces are so strong that the magnetic force is the ideal to balance such force. Iron core coils have so much more induction than air core because the core transfers the magnetic flux increasing the current induced. By this method, the iron core coil can have the advantage of low cogging similar to the air core, and the high induction of the iron core. In this case, the resulting balanced force is made in only part of the attracting forces as it can be a smaller stroke movement than the reach of magnetic forces.

The foregoing has outlined rather broadly the features and technical advantages of the present invention in order that the detailed description of the invention that follows may be better understood. These and other features and advantages along with other embodiments of the present invention will become apparent from the detailed description below, in light of the accompanying drawings.

### BRIEF DESCRIPTION OF THE DRAWINGS

The novel features which are believed to be characteristic of the present disclosure, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of examples in association with the accompanying drawings in which:

FIG. 1 illustrates different forces that interact between two magnets, according to an exemplary embodiment of the present invention;

FIG. 2 illustrates different forces involved between two magnets when separated or united by sliding them by sides, according to an exemplary embodiment of the present invention;

FIG. 3 illustrates a configuration for generation of potential energy, according to an exemplary embodiment of the present invention;

FIG. 4 illustrates generation of potential energy and transformation of the potential energy into kinetic energy by allowing movement, according to an exemplary embodiment of the present invention;

FIG. 5 illustrates generation of continuous power by making a rotational cycle, according to an exemplary embodiment of the present invention;

FIG. 6 illustrates a configuration to make more efficient power generation, according to an exemplary embodiment of the present invention;

FIG. 7 illustrates another configuration for the same principle, in which lateral or rotational magnetic change is used to produce axial or oscillating movement to produce power, according to an exemplary embodiment of the present invention;

FIG. 8 illustrates another configuration for the same principle, according to an exemplary embodiment of the present invention;

FIG. 9 illustrates a permanent magnet being attracted into an iron core formed by the iron core or a material made of a magnetic material, according to an exemplary embodiment of the present invention;

FIG. 10 illustrates an arrangement of components to balance an attracting force of a permanent magnet being attracted into an iron core, according to an exemplary embodiment of the invention;

FIG. 11 illustrates interaction between forces, according to an exemplary embodiment of the invention;

FIG. 12 illustrates a chart with an attracting force, according to an exemplary embodiment of the invention; and

FIG. 13 illustrates a stroking force, according to an exemplary embodiment of the invention.

FIG. 14 shows the interaction of two stroking permanent magnet units in combination, according to an exemplary embodiment of the invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a system for converting linear or rotational movement into a reciprocating motion to generate or convert power. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a system for converting linear or rotational movement into a reciprocating motion to generate or convert electric power. Further, the system facilitates generation of electric power in a high density by using iron core coil or any other suitable high permeability core to increase magnetic flux induced into the coil. Unless stated otherwise, terms such as “first” and “second” are used to arbitrarily distinguish between the elements. Thus, these terms are not necessarily intended to indicate temporal or other prioritization of such elements. While various exemplary embodiments of the disclosed system and method have been described below, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope of the present invention.

The method and the system for generating electric power by a linear movement or a rotation movement will now be described with reference to the accompanying drawings, which should be regarded as merely illustrative without restricting the scope and ambit of the disclosure.

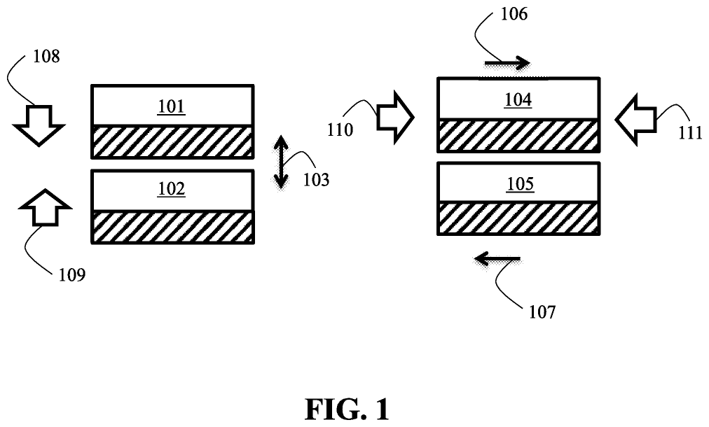

FIG. 1 illustrates different forces that interact between two magnets, according to an exemplary embodiment of the present invention. With reference to FIG. 1, a permanent magnet (such as a magnet 101) showing a polarity different from a polarity shown by another permanent magnet (such as a magnet 102) experiences a force of attraction 108 of the magnet 101 to the magnet 102. The magnet 102 also experiences a force of attraction 109 in a mutual way. The force 103 to separate the magnets 101 and 102 in direct opposite vector to the attracting forces 108 and 109 is higher than the forces 106 and 107 that are applied to identical permanent magnets (such as a magnet 104 and a magnet 105) to separate them sliding to a side, even though the magnetic forces 110 and 111 pulls to align them. This is a very simple observation. It can be seen even in manuals on how to separate strong magnets, that is easier to make it by the sides. This is just an observation to consider with the others here shown to understand the invention principles. It is less force needed to approach or separate a magnet in lateral form than doing it directly and counter fighting the force between the faces of a magnetic field.

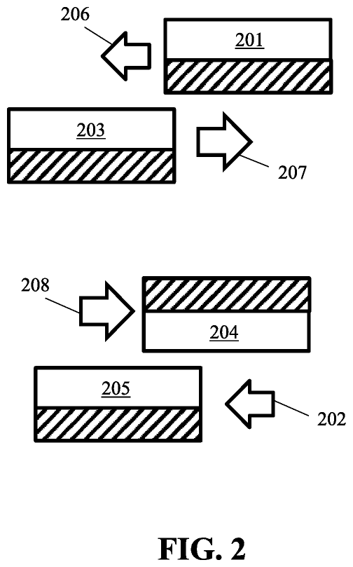

FIG. 2 illustrates different forces involved between two magnets when separated or united by sliding them by sides, according to an exemplary embodiment of the present invention. For example, a permanent magnet (such as a magnet 201) attracting to another permanent magnet (such as a magnet 203), when approached by a side showing a different polarity, experiences a force 206. The force 206 tries to align them (i.e., the magnets 201 and 203) to a point where the attracting forces are the strongest. The other magnet 203 experiences the same force 207. If the magnets 201 and 203 are left to move freely in a lateral way, then they will move to be aligned. In the counterpart of this attracting forces, if identical permanent magnets (such as magnets 204 and 205) are approached by the sides in a lateral movement having their faces shown the same polarity, then they will experience very similar forces 208 and 202 but in the opposite direction, trying to separate them. This is a phenomenon easy to observe and understand but critical to the invention made.

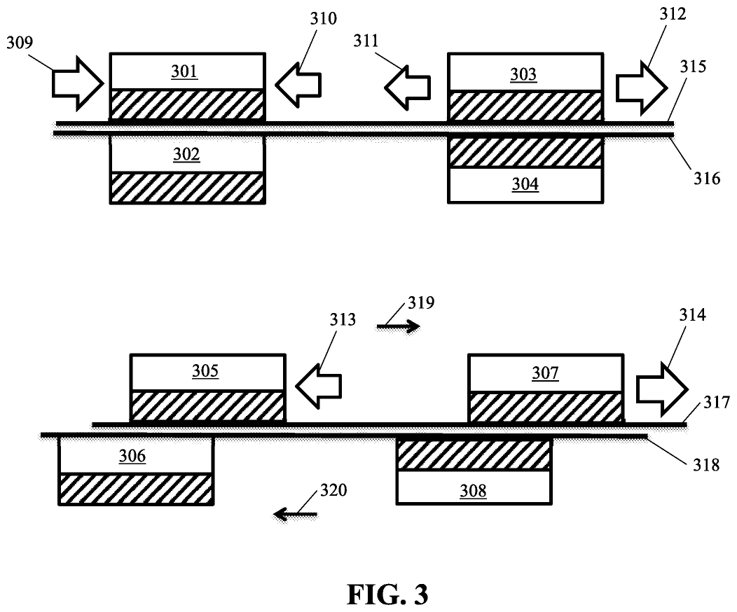

FIG. 3 illustrates a configuration for generation of potential energy, according to an exemplary embodiment of the present invention. The configuration, as shown in FIG. 3, facilitates the generation of the potential energy by the previously described principles, and applying little or no load to generate the potential energy. Here, as shown in FIG. 3, a structure 315 holds two permanent magnets (such as magnets 301 and 303) and keeps the magnets 301 and 303 in equidistance to another structure 316 that holds two other permanent magnets (such as magnets 302 and 304). The magnet 301 shows a different polarity to the face of the opposing magnet 302. This produces a force that attracts them (i.e., the magnets 301 and 302) and the forces 309 and 310 aligns the magnets 301 and 302. Being other magnet 303 in the same structure 315 than the attracting magnet 301, it will keep equidistance. The magnet 303 shows a similar polarity to the face of the opposing magnet 304 that is retained by a structure 316. Thus, the magnets 303 and 304 experience a rejecting force that becomes a potential energy, as the magnet 303 rejects the opposing magnet 304. Also, lateral forces 311 and 312 are created trying to put them apart. The resulting lateral forces for the complete upper structure 315 in relation to the lower structure 316 are very close to zero. When a similar configuration is made with the capability to move one structure 317 in a lateral form, the force 313 pulling together the opposing magnet 305 to its counterpart magnet 306 is very similar or identical to the force 314 of the magnet 307 in the same structure 317, thereby rejecting the opposing magnet 308 that tries to separate them, making a very little work or no work at all to make the lateral move of one structure 317 to the other, with little force 319 applied to one structure 317 or the other force 320 applied to the other structure 318. This low or no load movement to produce the potential power between the magnets 305 and 306 (that are attracting each other) or the magnets 307 and 308 (that are rejecting each other) allows to produce the potential energy with very low or no load. The potential energy may not useful if it is not liberated, so later will be shown and described how, as it is first needed to produce potential energy by this method, the potential energy is given by the attracting magnet 301 trying to unite to the opposite magnet 302, and the rejecting magnet 303 trying to separate from the opposite magnet 304 and the force of them is superior to the forces 319 and 320 needed to produce them. The explanation of the potential energy generation without load or a little load is the main objective for this figure.

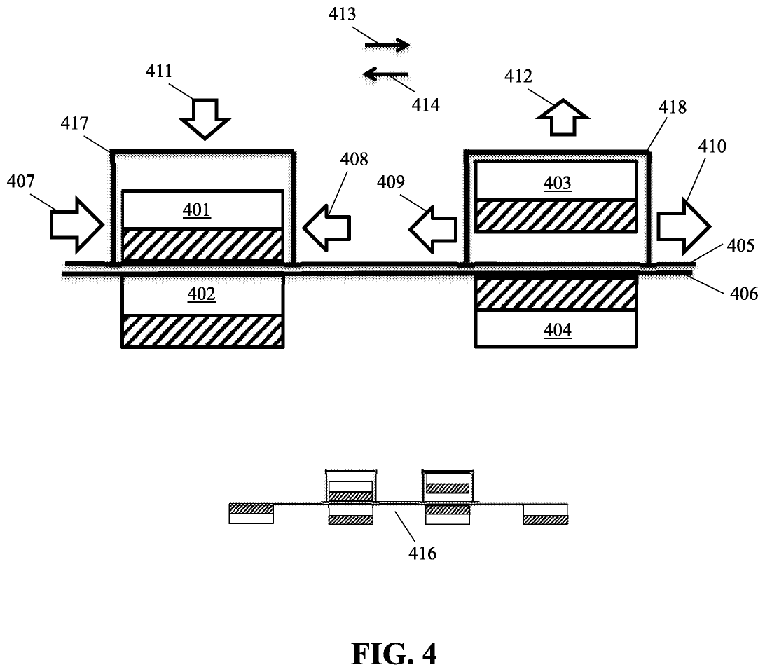

FIG. 4 illustrates generation of potential energy and transformation of the potential energy into kinetic energy by allowing movement, according to an exemplary embodiment of the present invention. Basically, with reference to FIG. 4, it is illustrated how the potential energy is generated and transformed into kinetic energy by allowing movement. In FIG. 4, there is shown a part of an arrangement of magnets in two structures composing a complete machine 416. FIG. 4 concentrates in the center of the machine to illustrate the mechanism. A structure 405 can move in a lateral form and an opposing structure 406 is in fixed position. Opposing permanent magnets (such as magnets 402 and 404) are fixed and form part of the lower structure 406. In the upper structure 405, a permanent magnet (such as a magnet 401) is located in a cavity 417 that holds the magnet 401 and the magnet 401 is not able to turn or move to the sides but is capable to make a stroke movement. The ideal movement is horizontal to avoid gravity effect in the movement but here has been shown in vertical for explanation that can also work effectively and efficiently in operation. Another permanent magnet (such as a magnet 403) in the upper structure 405 is opposite to the counterpart magnet 404 with the similar cavity 418 allowing the stroke in the cavity 418, (as explained in the previous figure) in which the configuration of the polarity of the magnets 403 and 404 facing to each other allows the two structures 405 and 406 to move in the lateral form without applying much force to one side 412 or force into the other 413. The magnetic force 411 of the magnets 401 and 402 attracting each other and the magnetic force 412 of the magnets 403 and 404 rejecting each other are much more than the needed forces 413 and 414 to move the upper structure 405 to one side 412 or the other. The force to move the upper structure 405 laterally is given by the difference between the forces 407 and 408 that keep the magnets 401 and 402 aligned of the magnetic attraction and the forces 409 and 410 of the rejecting magnets 403 and 404. The result is no resistance to the lateral movement, i.e., the lateral forces have a lower resulting force when the moving opposing magnets 401 and 403 have the same distance to their opposing counterpart magnets 402 and 404. As a result, the lateral resistance to the movement is in relation to the distance difference which is higher in the attracting forces 407, 408, and 411 than the rejecting force 412 and the lateral forces 409 and 410 because the magnets 401 and 402 are closer. Even when the lateral forces 413 and 414 are needed for the movement, the stroking forces 411 and 412 are higher and there is a gain. When the magnets 401 and 402 attract, they will always be closer than when the magnets 403 and 404 reject. This will result in the force of attraction 411 being higher than the force of rejection 412. This makes the forces 407 and 408 impeding the lateral movement forces 413 and 414 because they are higher than the forces 409 and 410 that want to make the lateral movement. This result in the need of the force to make the lateral movement 413 and 414 that can also be reduced and has been shown in the next figures.

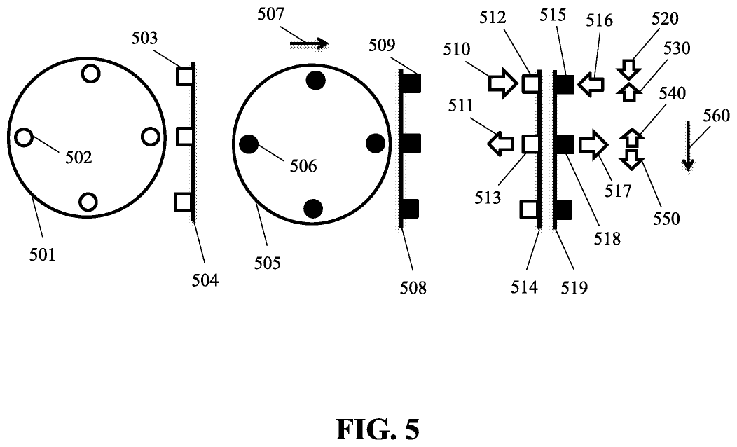

FIG. 5 illustrates generation of continuous power by making a rotational cycle, according to an exemplary embodiment of the present invention. Basically, with reference to FIG. 5, it is illustrated how to make the rotational cycle to make the continuous power generation. Also, linear cycles can be made by the same principles. The rotation cycle is composed of one circular fixed position structure 501. The circular fixed position structure 501 is attached to four stroking permanent magnet mechanisms 502 that allow the stroking of permanent magnets and can extract power by a mechanism like a linear alternator, without limiting the scope of present invention. In the lateral view, a fixed circular structure 504 holds the four permanent magnet stroking mechanisms 503 that can generate the power by the above described method in the previous figure. Further, positioning a rotational structure 505 that holds permanent magnets 506 attached to it, can spin in front of a first structure 514 that is fixed, and a rotational structure 519 spins in front of the first structure 514. This makes permanent magnets 515 (fixed in the rotating structure 519) have an intermittent or alternating magnetic fields into stroking mechanisms 512 of the static structure 514 due to the forces generated between permanent magnets 516 in the rotational structure 519 and the permanent magnets in the stroking mechanisms 512. There will be variation of magnetic forces between them given by the rotational movement 560. This will translate into stroking parts in the stroking mechanisms 510 and 511 producing power that can be extracted by the linear alternator or other mechanisms. The rotational movement 560 will be limited by the resulting force of the interaction between lateral forces 520, 530, 540, and 550 of magnets, that will be constantly vitiating during the rotation, requiring force to be spin. The result is mechanical movement in the stroking mechanisms 512 and 513 that can be used to produce the power, such as electrical or mechanical power.

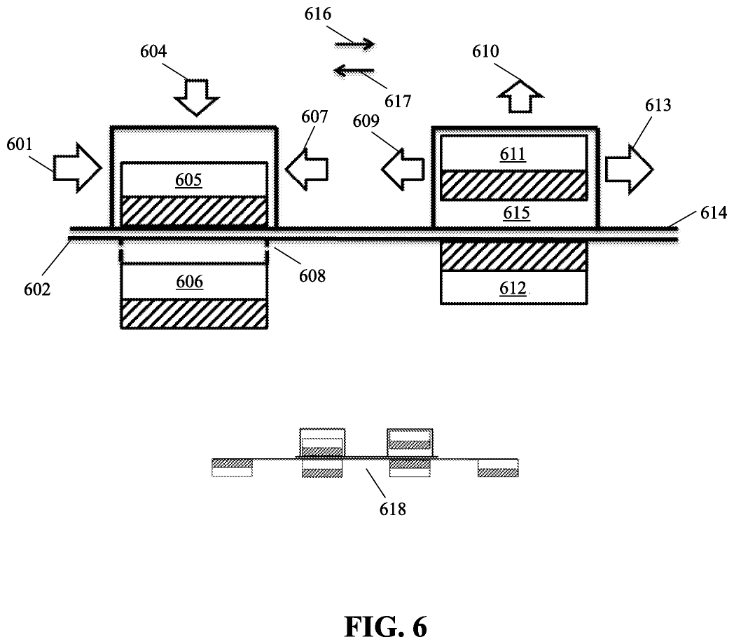

FIG. 6 illustrates a configuration to make more efficient power generation, according to an exemplary embodiment of the present invention. It has already been defined how the lateral forces 601 and 607 trying to align the magnets that are attracting 605 and 606 produce lateral forces 601 and 607 that can be balanced with the lateral forces 609 and 614 that try to separate the rejecting magnets 611 and 612. This result in a very neutral resulting lateral force that permits to easily make lateral movement between the structures. Also, it has been observed that the stroking movement to extract power produces a distance difference when the magnet 605 attracts than when the magnet 611 separates. This distance difference makes the small difference in forces that produces some resistance to the lateral movement. This can be managed by making a stroke short enough not to exceed the needed lateral force from the force obtained from the stroke, as it is given by the distance difference, or it can be configured that the magnets 605 and 606 attracting have a separation 608 to compensate the distance 615 that the rejecting magnets 611 and 612 result. This has an effect reducing the attracting force 604 between the magnets and also the lateral forces 601 and 607 that resist the lateral movement 616 and 617, making it easier to make the lateral movement 616 and 617 that can result in a circular movement making a less load and work for the motive power producing the cycle.

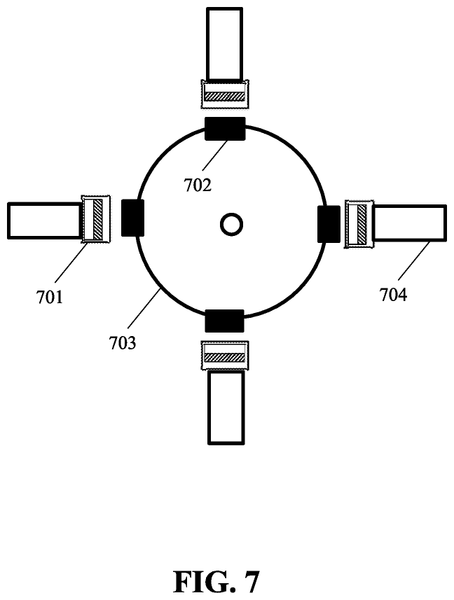

FIG. 7 illustrates another configuration for the same principle, in which lateral or rotational magnetic change is used to produce axial or oscillating movement to produce power, according to an exemplary embodiment of the present invention. Basically, with reference to FIG. 7, a different configuration is shown for the same principle and they all are lateral or rotational magnetic change to produce axial or oscillating movement to produce power. The magnetic change can be by alternating the polarity, being the same polarity, inverting the polarity, or the same polarity changing the intensity, by electromagnet change of intensity or polarity or by permanent magnet movement changing the intensity or the polarity of the permanent shown to the stroking permanent magnet mechanism.

In FIG. 7, there is a circular rotating structure 703 that holds four permanent magnets 702 that are configured so that the lateral forces are the most balanced possible to have easily been spin into permanent magnet stroking structures 701 that generate power. The power is generated by power generators such as linear alternators 704 that will produce electric power.

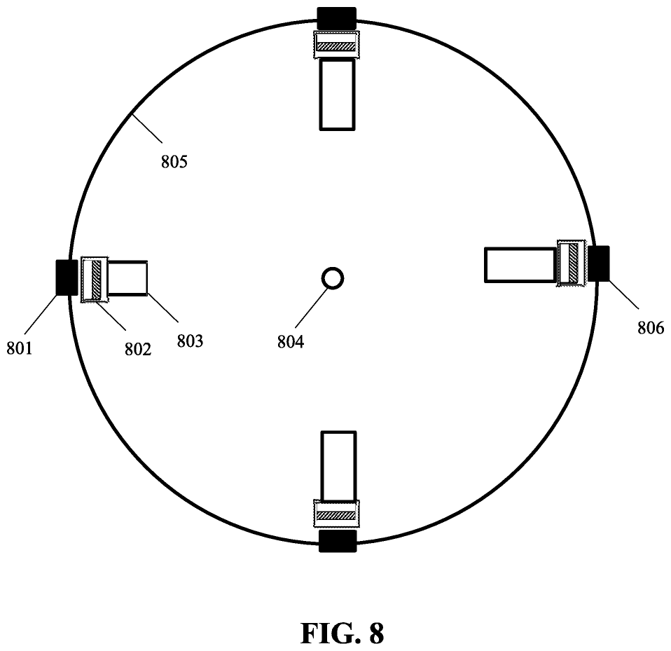

FIG. 8 illustrates another configuration for the same principle, according to an exemplary embodiment of the present invention. With reference to FIG. 8, there is shown satellite magnets 802. The satellite magnets 802 are fixed to a rotational structure 805 to make permanent magnets 801 to spin. This makes an intermittent or alternating magnetic flow between the satellite magnets 802 and the permanent magnets 801 in the oscillating mechanism 802, which can be used by some source of a power generation device like the linear alternator 803 or some source of a piston rod into a crankshaft to produce electrical power. The different orientation of the permanent magnets 801 and 806 polarity produces a lower resistance to the rotating movement preventing resistance and cogging.

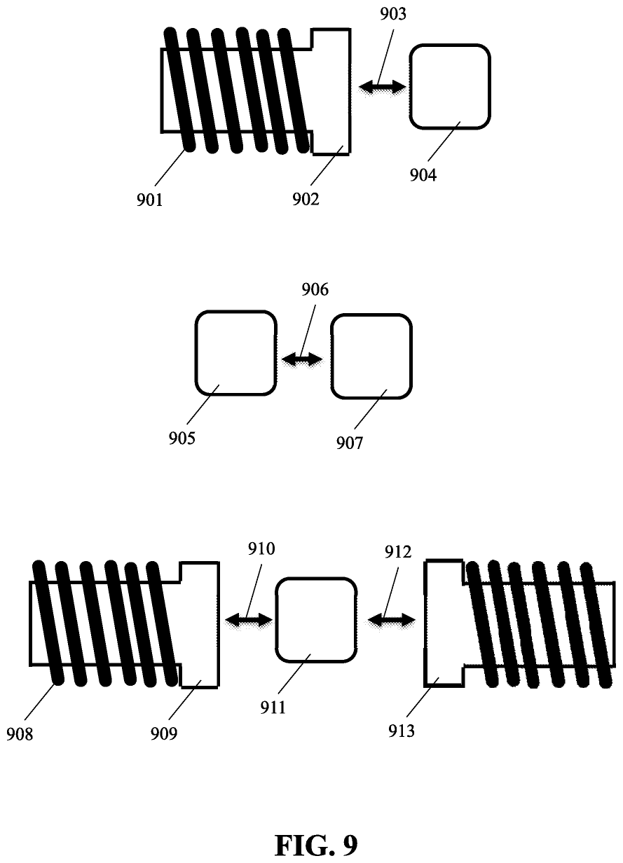

FIG. 9 illustrates a permanent magnet being attracted into an iron core formed by the iron core or a material made of a magnetic material, according to an exemplary embodiment of the present invention. In FIG. 9, a permanent magnet 904 is attracted into an iron core 902 formed by the iron core 902 or a material made of magnetic material to increase the magnetic flux to the bobbin 901 made of copper. Iron core coils or other suitable high permeability cores (for example but not limited to core made of amorphous core, nanocrystalline, permalloy etc) are useful because the magnetic permeability is transferred to the coil. Therefore, the induced current is higher, when the magnet is attracted to this magnetic core. The attraction produces a force 903. This force 903 produces a cogging. It requires the force 903 to put them apart and forces them to attract when moving towards the iron core 902 into the permanent magnet 904. This phenomena in rotor motors can be observed as a cogging. Here, in linear motors, it can be seen as the force needed to overcome the magnetic attraction to separate them. The induction is given by the magnetic flux change so that the coil produces electricity in both ways, being unbalanced in force to be used in a linear generator. The magnetic attraction is an exponential increment and it applies in a very short distance, for example, in just one millimeter, the attraction power between a permanent magnet and a magnetic material can vary in more than 30%, which is hard to contra rest with a spring or mechanical movement. Being two permanent magnets 905 and 907 and being put in front of each other by the same polarity, they will experience a rejecting force 906 to each other. This force 906 is also increased exponentially by the reduction of the distance, even though the attraction of a permanent magnet to iron, steel or magnetic material, is not identical to the force experienced due to the rejection to another permanent magnet. This can be calculated and balanced by choosing the grade of the permanent magnet, the dimensions, or the distance between the objects. It is possible to make this balance by counter force of attraction of the permanent magnet 911 to a magnetic material or a counterpart coil 913. It may be possible but not so efficient. It may produce the same effect but not with the same efficiency, as the counter force 912 putting them together reduces with the distance while the other force 910 increases by reducing the distance. This makes the permanent magnet 911 into a mid-position and requiring force to either side, lower than the force needed to do it without the balance.

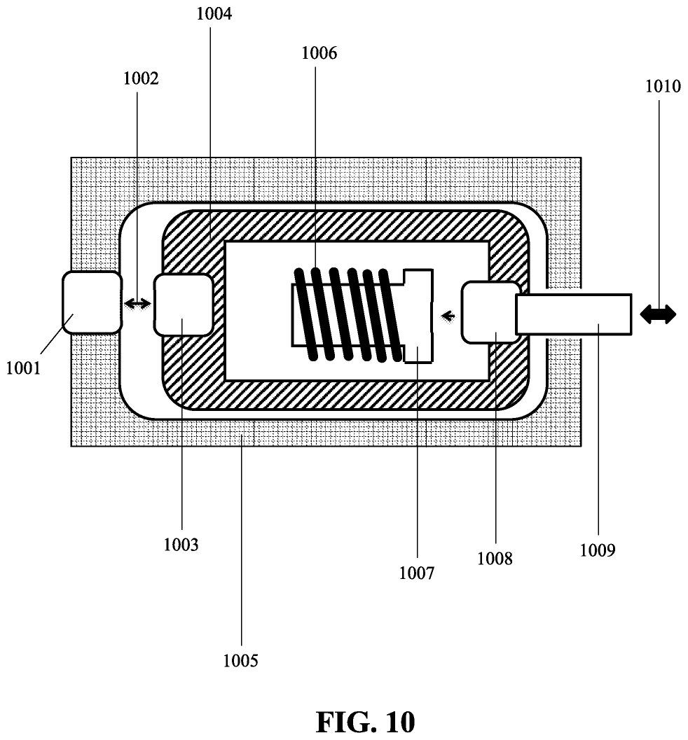

FIG. 10 illustrates an arrangement of components to balance an attracting force of a permanent magnet being attracted into an iron core, according to an exemplary embodiment of the invention. FIG. 10 shows the arrangement of the components to balance an attracting force 1011 of a permanent magnet 1008 that is being attracted into the iron core of a coil 1007 with a force 1002 of a permanent magnet 1001 being rejected by another permanent magnet 1003. By this arrangement, the resulting force 1010 is lower than the forces 1002 and 1011. Being this force 1010. The induction resulting in a coil 1006 is in relation to the applied force, and so this way, it is required a lower peak force. This way, it is a lower force required during one of the direction (when the iron core separates from the permanent magnet) and is higher in the other direction (when the permanent magnet approaches the iron core coil), but the required peak force is lower. In all the cases, the sum of the forces is zero, and the peak power is lower in this configuration. This helps to obtain the power from low power sources and is capable to make the force of the balanced movement, but not the force 1011 of removing the permanent magnet 1008 from the iron core 1007 alone without the balance. This source of force (that is capable of overcoming the balanced force 1010) could also be used by using air core coils, which do not produce the attracting force as the iron core 1007, but the air core coils transfer less magnetic force and therefor induce less electricity, needing much more space and material. This coil configuration increases a lot the inductance, which can increase the reluctance in AC generation during the reciprocating movement, it can produce power as AC alternator or generator, and can also be configured to half wave power generator, bridged into half wave so one way produces electric power and the other way of the movement it produces eddy currents and heat, being a half wave linear DC generator, which is not very efficient but may enable to generate more power by the same coil due the reluctance of such high inductance.

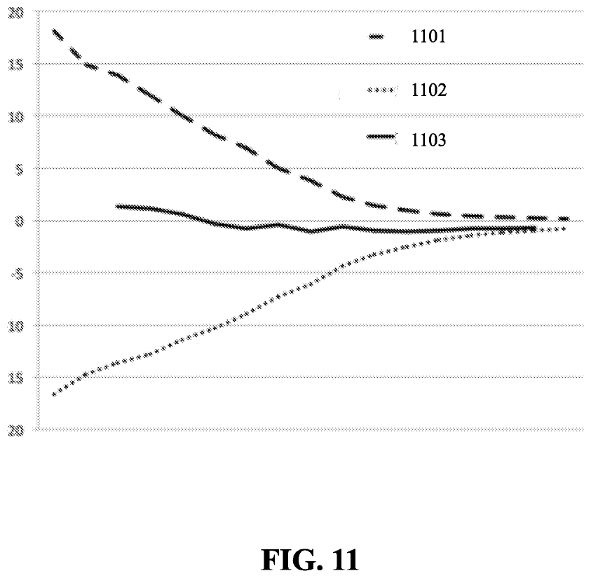

FIG. 11 illustrates an interaction between forces, according to an exemplary embodiment of the invention. In FIG. 11, the interaction between the forces, as described above, has been shown. FIG. 11 is a chart with the attracting forces in the Y axis. One line 1101 shows the magnetic rejection of two permanent magnets that are put in the front, one of the other, by the same polarity. In this case, estimated with ½ Inch diameter round N52 permanent magnet with ⅜ inch width at a distance of zero to a distance of ½ inch, where the force changes from almost twenty pounds of force rejecting them, to almost zero. In the counterpart, the iron core, being attracted to a ½ inch round N52 permanent magnet, produces an attraction force 1102. The attraction force 1102 is represented as negative as it opposes the other force. The permanent magnet sizes were selected to exemplify the balancing of forces as the attraction to iron might not be the same as the rejection between identical magnets. But they can be selected to be close to equal and balance the resulting force 1103. Here, it can be seen that the resulting force 1103 that is the sum of both the forces 1101 and 1102 is more stable requirement. And there is no difference in the results of forces as this forces change of sign when the movement of the induction magnet is made in the other way, having negative forces. In both the cases, the complete cycle sum of the forces is zero. By this innovation, the peak force is lower, making possible the movement for lower sources of force. In this representation, the resulting balanced force is made in only part of the attracting forces as it can be a smaller stroke movement than the reach of the magnetic forces. It is shown by a smaller line that represents only the distance of the movement of the resulting force 1103.

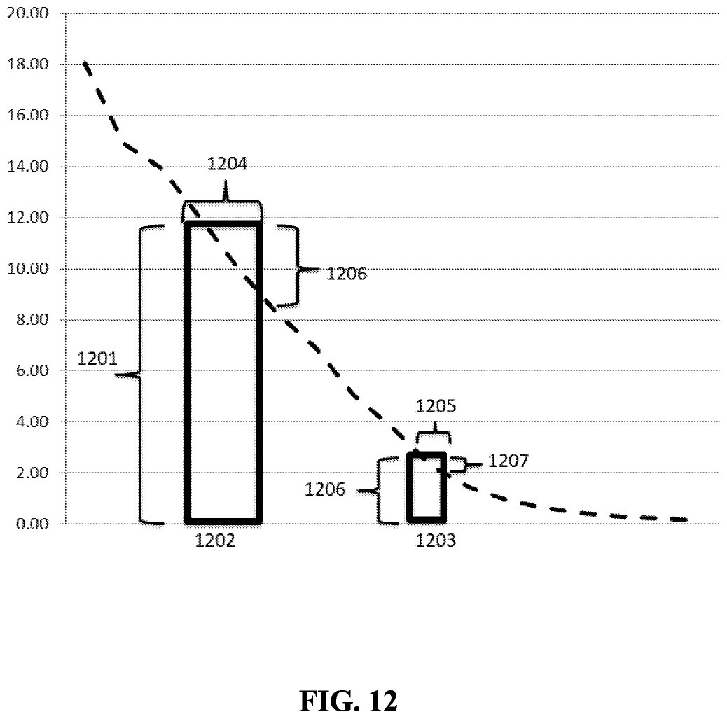

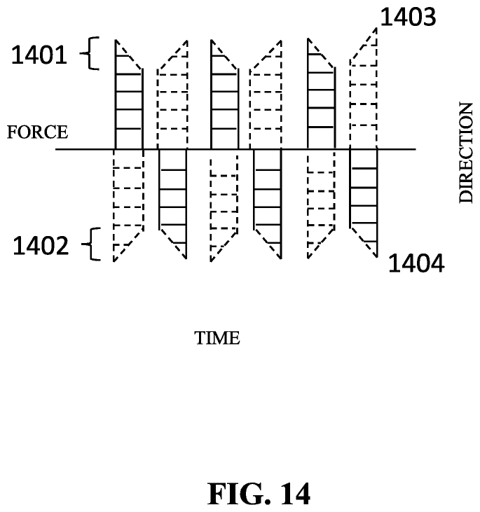

FIG. 12 illustrates a chart with an attracting force, according to an exemplary embodiment of the invention. The chart shows the forces produced by magnets repulsion or attraction (Y-Axis) Vs the distance between them (X-Axis) various modes of power that can be obtained from the various configurations as described above. For example, the chart in FIG. 12 shows the power obtained from the stroking. The chart further shows that two millimeters stroke movement 1202 can produce a longer period 1204 which results in more time and more difference in the power as compared to one millimeter stroke movement 1203 which period and force difference 1205 is lower, and that the force obtained is higher when magnets are closer which is the force at the left, being the movement 1202 higher force being due the magnets being closer. The force needed to move the magnets that produce the movement is not related to the force of the stroking, it is related to the force difference between the starting and the finishing force of the stroking 1206, 1207, which can also be balance by other similar movement working at the same time and counter acting that forces which will be shown in FIG. 14.

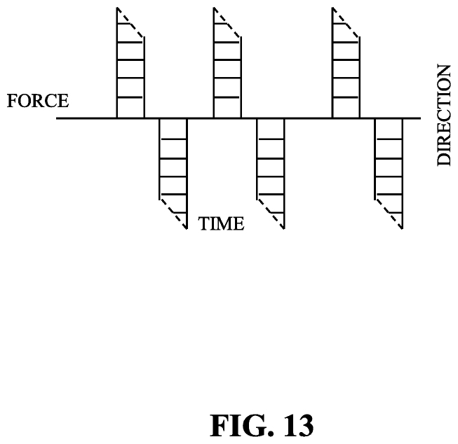

Thus, the machine is set to obtain more power from the stroking movement than the torque needed to rotate. The relation between them all is shown in the chart of FIG. 12. The chart shows the line of force of attraction in a given magnet in pound of attraction (repelling is identical force). Energy is given by force or power and the duration. The stroke receives the total force of the magnet, and the torque needed only receives the difference between the magnets that attracts to the magnet that repels. This can be compensated by giving a gap to the attracting magnets. Stroking force should look like as shown in FIG. 13. This can be converted by linear alternator and create a very similar wave form like this in electric power. Time or duration of the movement is given by (RPM)/(number of magnets). For example, for 1000 RPM with 4 magnets, the time is determined as 1000/4 (=4000 strokes per minute). The distance is given by perimeter formula (2*pi*r)/(number of magnets), where r is the radius is the radius of the structure 501. The torque needed is given the force*time*distance. The force is given the magnet forces distance and not the total force. The input energy is given by T=F*L, where T is the torque, F is the force in Newton-meter, and L is the length of the vector.

The output power is given by the force in its total power which is much more. The time is given by the time of stroking * the number of magnets * RPM Duration=Time stroking * number of Magnets * Revolution * Minutes Both times are equal when:

Revolution Time=Time of stroke * number of magnets Both the forces can be compared and calculated to obtain the net output by the common formula:

Power (kW)=Torque (N-m) * Speed (RPM)/9.5488

Torque is the required input power, while KW is the value to be compared to output power of the stroke.

Permanent Magnets come from variety of materials and dimensions that result in a very wide range forces that has no actual way to be defined into common formula to obtain the delta difference in force, given the delta distance between the stoke starting and finishing.

FIG. 14 shows the interaction of two stroking permanent magnet units in combination, where the force intervals and intensity of one stroking movement is shown 1403, in contrast to other stroking piston 1404, the total force is used by the linear generator while the torque is affected only by the power difference 1401, 1402, by being one magnet attracted at the time that the other is rejected in the same rotor or linear movement the forces in the rotor oppose each other being the force 1401 rested from the force 1402, the forces are not identical but they do result in less torque or no load to the power or movement motivation shaft, therefore making the movement very efficient.

Although particular embodiments of the invention have been described in detail for purposes of illustration, various modifications and enhancements may be made without departing from the spirit and scope of the invention.

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports.

1-5. (canceled)

6. A power generation mechanism, comprising:
making a linear or rotational movement of a first arrangement of permanent magnets that transfer magnetic forces into a second single or plurality of permanent magnets stroking movement by the magnetic forces exchange; and
converting the linear or rotational movement into a reciprocating motion for power generation;
wherein converting the linear or rotational movement into the reciprocating motion for power generation includes one or more of:
electromagnetic forces (attraction or repelling) of every permanent magnet in the first arrangement of permanent magnets to the second single or plurality of permanent magnets in the reciprocating movement is counter acted or balanced by an opposite magnetic force (repelling or attraction) to reduce, neutralize, or eliminate a needed torque or togging to make the first arrangement to move linearly or rotationally, reducing needed force and energy input;
the attraction or repelling force produced by the permanent magnet in the linear or rotational movement to the permanent magnet or magnets in the reciprocating movement that resist the linear or rotating movement are counter acted by one or many other counter acting force of permanent magnets in other reciprocating movements or static with no movement balancing, reducing or eliminating the required cogging or torque force in the linear or rotary movement, increasing the efficiency;
the permanent magnets in the linear or rotational movement have a gap or a distance difference to the permanent magnets in the reciprocating movement depending on a polarity, to counter act the force difference of permanent magnets by distance made by the reciprocating movement stoke, resulting in more similar forces when repealing than attracting, resting in a reduced or eliminated needed cogging or torque force in the linear or rotational movement; and
the reciprocating movement is short so the magnetic forces between the permanent magnets in the linear or rotational movement into reciprocating movement remain similar at the closer point between linear or rotational movement to the reciprocating movement and the largest distance between them so there is small or no force difference when attracting than when rejecting, reducing the needed cogging or torque force in the linear or rotational movement.

7. The power generation mechanism of claim 6, wherein the linear or rotational movement arises from one or more sources comprising at least one of an electric AC motor, an electric DC motor, or an internal combustion engine.

8. The power generation mechanism of claim 6, wherein the electric power is generated in a high density by using a high permeability core to increase induced magnetic flux.

9. The power generation mechanism of claim 8, wherein, to reduce the needed force to allow the stroking movement, a force needed to overcome attraction of a permanent magnet to the high permeability core is reduced by a contrasting the attracting force of the permanent magnet to the high permeability core with a force of permanent magnets repelling or attracting each other.

10. The power generation mechanism of claim 8, wherein, to allow the movement, a force needed to overcome attraction of a permanent magnet to the high permeability core is reduced by contrasting an attracting force of the permanent magnet that induces the high permeability core with a force of two permanent magnets opposing each other by being fronted by the same polarity.
